(19) United States
(12) Patent Application Publication
(10) Pub. No.: US 2024/0068580 A1
(43) Pub. Date: Feb. 29, 2024

(54) FLOW PASSAGE SWITCHING DEVICE

(71) Applicant: AISAN KOGYO KABUSHIKI KAISHA, Obu-shi (JP)

(72) Inventors: Shinji KAWAI, Gifu-shi (JP); Mamoru YOSHIOKA, Obu-shi (JP)

(73) Assignee: AISAN KOGYO KABUSHIKI KAISHA, Obu-shi (JP)

(21) Appl. No.: 18/229,492

(22) Filed: Aug. 2, 2023

(30) Foreign Application Priority Data
Aug. 29, 2022 (JP) 2022-135866

(51) Int. Cl. F16K 11/074; F16K 3/02; F16K 3/08; F16K 27/04

(52) U.S. Cl. CPC F16K 11/074; F16K 3/0209; F16K 3/0227; F16K 3/08; F16K 27/045

(57) ABSTRACT

A passage switching device to switch flow passages includes a rotary disk and a fixed disk which are stacked in an axial direction. The rotary disk is provided with at least one rotary disk communication path penetrating in the axial direction, and the fixed disk is provided with a plurality of fixed disk communication paths penetrating in the axial direction. The flow passages are switched by rotating and driving the rotary disk to switch combination of the rotary disk communication path and the fixed disk communication path for communication. There is provided an elastic member between the housing and the rotary disk, between the rotary disk and the fixed disk, and between the fixed disk and the housing with respect to the axial direction.

### CROSS-REFERENCE TO RELATED APPLICATIONS

This application is based upon and claims the benefit of priority from the prior Japanese Patent Application No. 2022-135866 filed on Aug. 29, 2022, the entire contents of which are incorporated herein by reference.

### BACKGROUND

### Technical Field

The present disclosure relates to a flow passage switching device for switching flow passages.

### Related Art

Japanese patent application publication No. 2022-21966 has disclosed a flow passage switching device provided inside a housing with a valve element part that includes a rotary disk and a fixed disk. In such a flow passage switching device, rotation of the rotary disk about a rotary shaft brings opening or closing of a communication path of the fixed disk to thereby switch the flow passages.

### SUMMARY

### Technical Problems

The flow passage switching device of the Japanese patent application publication No. 2022-21966 however has a possibility that the rotary disk of the valve element part could tilt by a fluid pressure, so that the rotary disk fails to keep its posture. This could result in degradation in the sealing performance of the communication path of the fixed disk, which could cause failure to prevent leakage of fluid from the communication path of the fixed disk. Further, there is also a possibility that a sealing member for ensuring the sealing performance of the communication path of the fixed disk could suffer from uneven wear.

The present disclosure has been made for solving the above problems, and has a purpose of providing a flow passage switching device that can prevent a valve element part from tilting due to a fluid pressure.

### Means of Solving the Problems

One aspect of the present disclosure for solving the above problem is a flow passage switching device comprising: a housing; and a valve element part provided in the housing, the valve element part including a drive disk of a plate-like shape and a fixed disk of a plate-like shape, the drive disk and the fixed disk being stacked in an axial direction, the drive disk including at least one drive disk communication path penetrating in the axial direction, the fixed disk including a plurality of fixed disk communication paths penetrating in the axial direction, and the drive disk being driven and rotated to switch a flow passage by changing combination of the drive disk communication path and the fixed disk communication path which communicate with each other, wherein elastic members are each provided in the axial direction between the housing and the drive disk, between the drive disk and the fixed disk, and between the fixed disk and the housing.

According to this aspect, the elastic member is provided in each space among the housing, the drive disk, and the fixed disk with respect to a central axial direction of the drive disk and the fixed disk, and thereby the elastic members support the drive disk and the fixed disk. Owing to the influence of the floating property, sliding resistance caused by application of fluid pressure can be restrained, and thus a sealing member for ensuring the sealing performance of the drive disk communication path and the fixed disk communication path can be prevented from uneven wear.

In the present aspect, preferably, at least one of the elastic members is a sealing member to prevent leakage of a fluid from any one of the drive disk communication path and the fixed disk communication path.

According to this aspect, the elastic member for keeping the posture of the drive disk and the fixed disk can be used also as the sealing member of the drive disk communication path or of the fixed disk communication path. Accordingly, increase in the number of components can be restrained. Further, the axial direction of the drive disk and the fixed disk is aligned with a sealing direction of the sealing member, and thus even if the drive disk gets misaligned from the central axis in rotary movement of the drive disk, the sealing performance can be ensured.

In the above aspect, preferably, the sealing member provided between the housing and the drive disk and the sealing member provided between the drive disk and the fixed disk are placed in the same position with respect to a surface direction of the drive disk.

According to this aspect, both faces of the drive disk, namely, a face opposing the housing and the other face opposing the fixed disk have the same area on which the fluid pressure acts. Accordingly, the fluid pressure acting on the both faces of the drive disk are offset from each other, thus keeping the posture of the drive disk. The sliding resistance between the drive disk and the fixed disk during rotary movement of the drive disk is thus reduced, so that the power for driving and rotating the drive disk can be lowered and electric power can be saved. Further, the load to be given to the sealing member from the drive disk is reduced, thereby improving the credibility of the sealing performance of the sealing member.

In the above aspect, preferably, at least one of the elastic members which is provided between the fixed disk and the housing is a fixed disk sealing member to prevent leakage of a fluid from the fixed disk communication path, and a tightening force of the fixed disk sealing member acts in the axial direction.

According to this aspect, the sealing performance of the fixed disk communication path can be ensured by the fixed disk sealing member, and also the posture of the fixed disk can be assured.

Further, the tightening force of the fixed disk sealing member acts on the fixed disk in the axial direction, and thus the fixed disk sealing member does not slide along the housing even if the fixed disk moves in the axial direction in order to keep its posture. Namely, there is no sliding resistance occurred between the fixed disk sealing member and the housing. Therefore, the posture of the fixed disk can be further assuredly held with no influence of the sliding resistance between the fixed disk sealing member and the housing.

Further, the tightening force of the fixed disk sealing member acts on the fixed disk in the axial direction, and thus a position of the central axis of the fixed disk communication path less varies to a direction orthogonal to the central axis as compared with a case that the tightening force of the fixed disk sealing member acts on the fixed disk in a direction orthogonal to the axial direction. Therefore, the sealing performance of the fixed disk communication path can be further assuredly ensured by the fixed disk sealing member.

In the above aspect, preferably, the housing includes an outflow channel communicated with the fixed disk communication path, the fixed disk includes a cylinder portion formed to surround the fixed disk communication path, and at least a part of the cylinder portion is inserted in the outflow channel.

According to this aspect, it is possible to prevent positional displacement of the fixed disk in the circumferential direction which is caused in association with the rotary movement of the drive disk.

### Effects of the Disclosure

According to a flow passage switching device of the present disclosure, a valve element part can be prevented from tilting due to a fluid pressure.

### BRIEF DESCRIPTION OF THE DRAWINGS

FIG. 1 an external perspective view of a flow passage switching valve as a six-port valve in first, second and third embodiments;

FIG. 2 is an exploded perspective view of the flow passage switching device in the first, second, and third embodiments in which illustration of a drive part is omitted;

FIG. 3 is a sectional view of the flow passage switching device in the first embodiment in which illustration of the drive part is omitted;

FIG. 4 is a top view of a rotary disk;

FIG. 5 is a top view of a fixed disk;

FIG. 6 is a conceptual diagram of a first pattern of flow passage combination;

FIG. 7 is a conceptual diagram of a second pattern of the flow passage combination;

FIG. 8 is a conceptual diagram of a first pattern of the flow passage combination in a case where the flow passage switching device is a three-port valve;

FIG. 9 is a conceptual diagram of a second pattern of the flow passage combination in the case where the flow passage switching device is the three-port valve;

FIG. 10 is a conceptual diagram of a first pattern of the flow passage combination in a case where the flow passage switching device is a four-port valve;

FIG. 11 is a conceptual diagram of a second pattern of the flow passage combination in the case where the flow passage switching device is the four-port valve;

FIG. 12 is a sectional view of the flow passage switching device in the second embodiment in which illustration of the drive part is omitted;

FIG. 13 is a sectional view of the flow passage switching device in the third embodiment in which illustration of the drive is omitted;

FIG. 14 is a diagram of a rotary disk of a semicircular configuration and a fixed disk in a related art; and

FIG. 15 is a diagram of a rotary disk of a whole circular configuration and a fixed disk in the related art.

### DETAILED DESCRIPTION OF THE EXEMPLARY EMBODIMENTS

A flow passage switching device 1 as one example of an embodiment of the present disclosure is explained.

### First Embodiment

Firstly, a first embodiment is explained.

Explanation for Overall Configuration of Flow Passage Switching Device

An overall configuration of a flow passage switching device 1 is now explained.

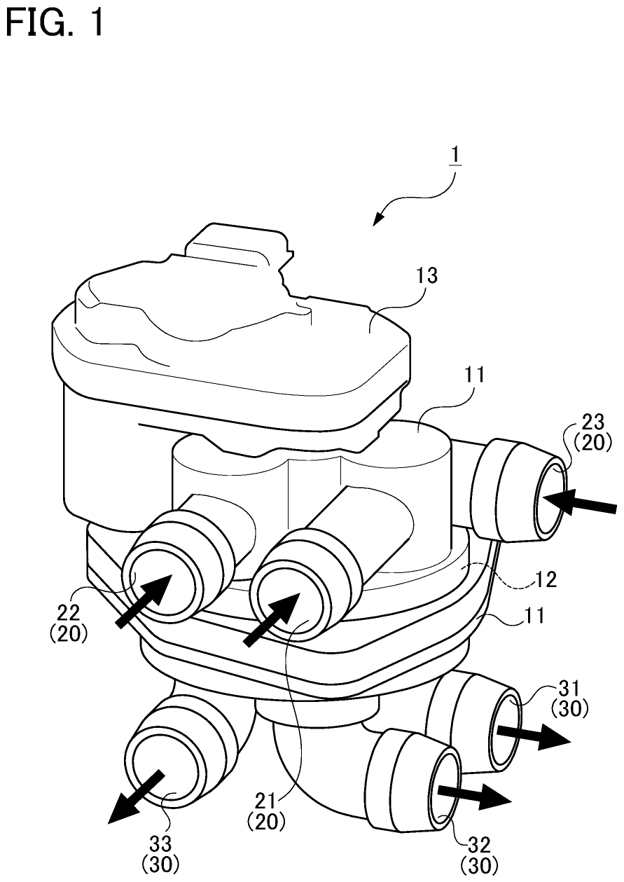

As shown in FIG. 1 to FIG. 3, the flow passage switching device 1 includes a housing 11, a valve element part 12, and a drive part 13.

The housing 11 includes an inflow channel 20 in which a fluid flows and an outflow channel 30 through which the fluid flows out. In the embodiment, the flow passage switching device 1 is a six-port valve as one example, and the housing 11 is provided with the three inflow channels 20 and the three outflow channels 30. As the three inflow channels 20, a first inflow channel 21, a second inflow channel 22, and a third inflow channel 23 are provided. Further, as the three outflow channels 30, a first outflow channel 31, a second outflow channel 32, and a third outflow channel 33 are provided. The housing 11 is made of resin, for example.

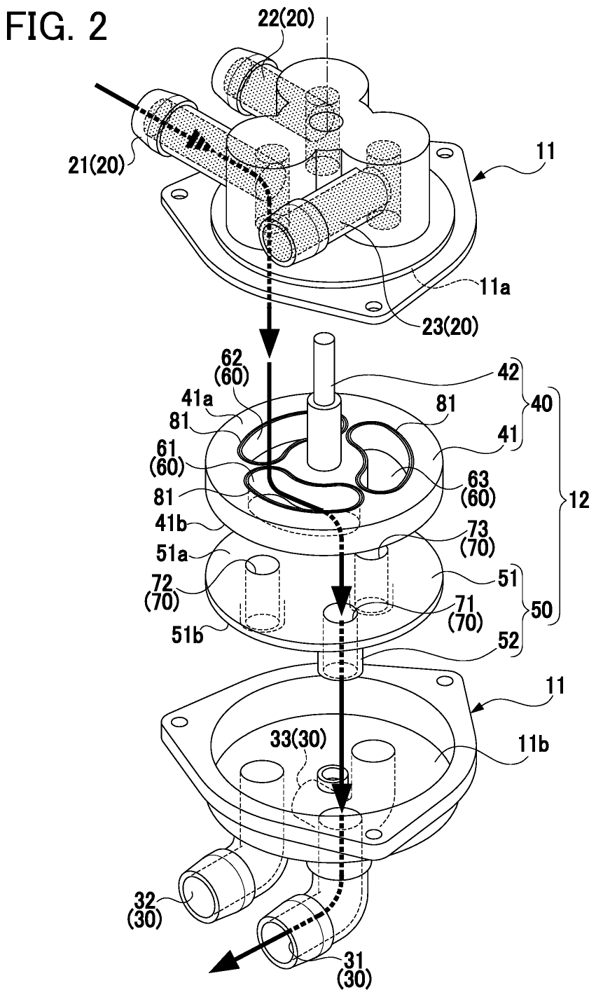

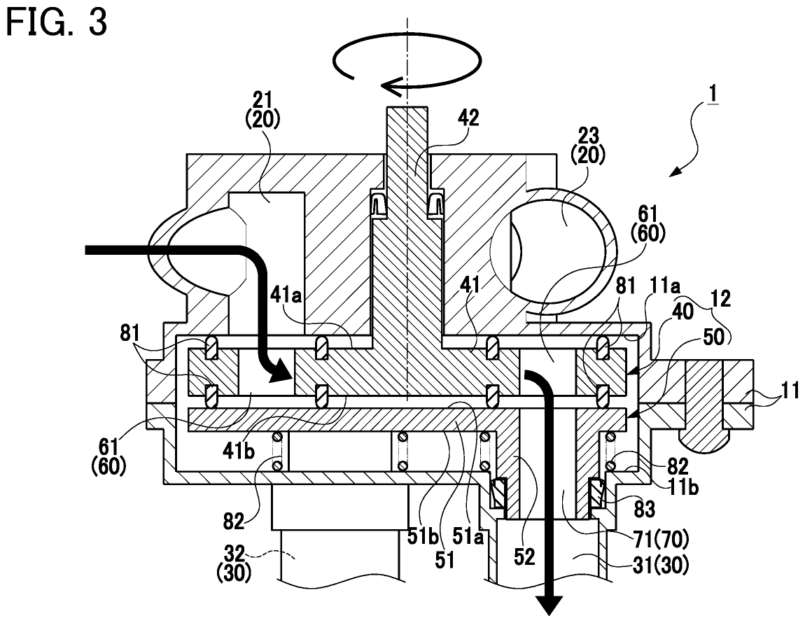

The valve element part 12 is provided in the housing 11. This valve element part 12 is, as shown in FIG. 2 and FIG. 3, provided with a rotary disk 40 of a plate-like shape that is to be driven and rotated and a fixed disk 50 of a plate-like shape. The rotary disk 40 and the fixed disk 50 are placed to be stacked one on the other in a central axial direction (hereinafter, simply referred as an “axial direction”) of a circular plate portion 41 of the rotary disk 40 and of a circular plate portion 51 of the fixed disk 50 which will be explained below.

The rotary disk 40 is one example of a “drive disk” of the present disclosure. Further, the rotary disk 40 and the fixed disk 50 are made of resin, for example.

As shown in FIG. 2 to FIG. 4, the rotary disk 40 is provided with the circular plate portion 41 and a rotary shaft portion 42.

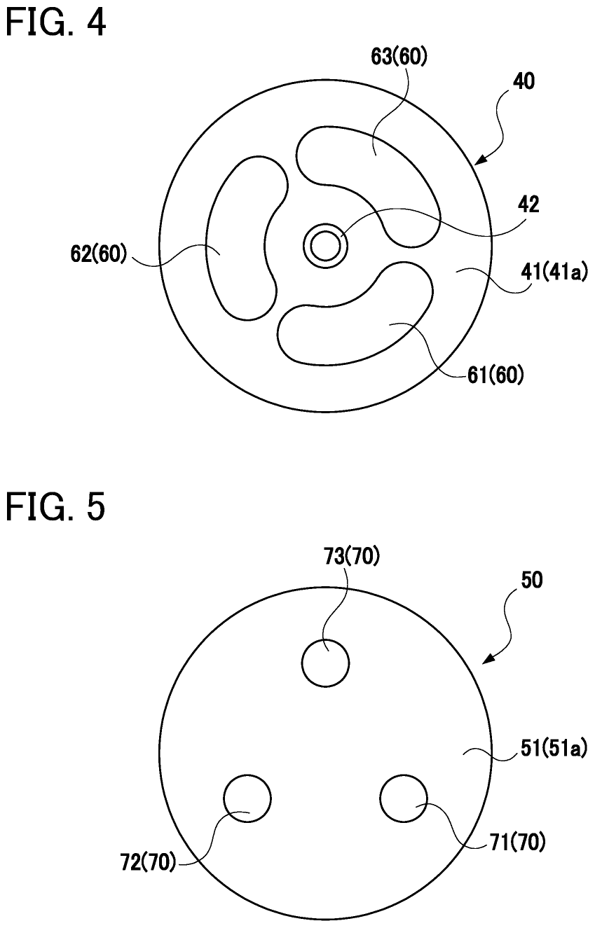

The circular plate portion 41 is formed to be of a circular plate-like shape and provided with rotary disk communication paths 60 penetrating in the axial direction. Herein, the circular plate portion 41 is provided with the three rotary disk communication paths 60. Specifically, as the three rotary disk communication paths 60, a first rotary disk communication path 61, a second rotary disk communication path 62, and a third rotary disk communication path 63 are provided as shown in FIG. 2 and FIG. 4. The rotary disk communication path 60 is one example of a “drive disk communication path” of the present disclosure.

The rotary shaft portion 42 is connected on one end with the circular plate portion 41 and on the other end with the drive part 13 with respect to the central axial direction. This rotary shaft portion 42 is provided in a center position of the circular plate portion 41 so that a central axis of the rotary shaft portion 42 is aligned with a central axis of the circular plate portion 41. Then, the rotary shaft portion 42 obtains a motive power for rotation from the drive part 13 to rotate about the central axis, and this rotation brings about rotation of the circular plate portion 41, which is connected to the rotary shaft portion 42, about the central axis. The rotary disk 40 thus obtains the motive power for rotation from the drive part 13 to rotate about the central axis.

As shown in FIG. 2, FIG. 3, and FIG. 5, the fixed disk 50 is provided with a circular plate portion 51 and cylinder portions 52.

The circular plate portion 51 is formed to be of a circular plate-like shape and provided with fixed disk communication paths 70 penetrating in the axial direction. Herein, the circular plate portion 51 is provided with the three fixed disk communication paths 70. Specifically, as the three fixed disk communication paths 70, a first fixed disk communication path 71, a second fixed disk communication path 72, and a third fixed disk communication path 73 are provided as shown in FIG. 2 and FIG. 5.

The cylinder portions 52 are connected to the circular plate portion 51 and formed to surround each of the fixed disk communication paths 70 and to extend in the axial direction from the circular plate portion 51. Herein, the three cylinder portions 52 are provided such that each of the cylinder portions 52 is placed as corresponding to each of the three fixed disk communication paths 70. At least a part of the respective cylinder portions 52 is inserted inside the respective outflow channels 30.

The drive part 13 is provided with a motor (not shown) to give a motive power for rotation to the rotary shaft portion 42 of the rotary disk 40.

The flow passage switching device 1 with the above-mentioned configuration switches flow passages by changing combination of communication of the three rotary disk communication paths 60 and the three fixed disk communication paths 70 by driving the rotary disk 40 to rotate by the drive part 13.

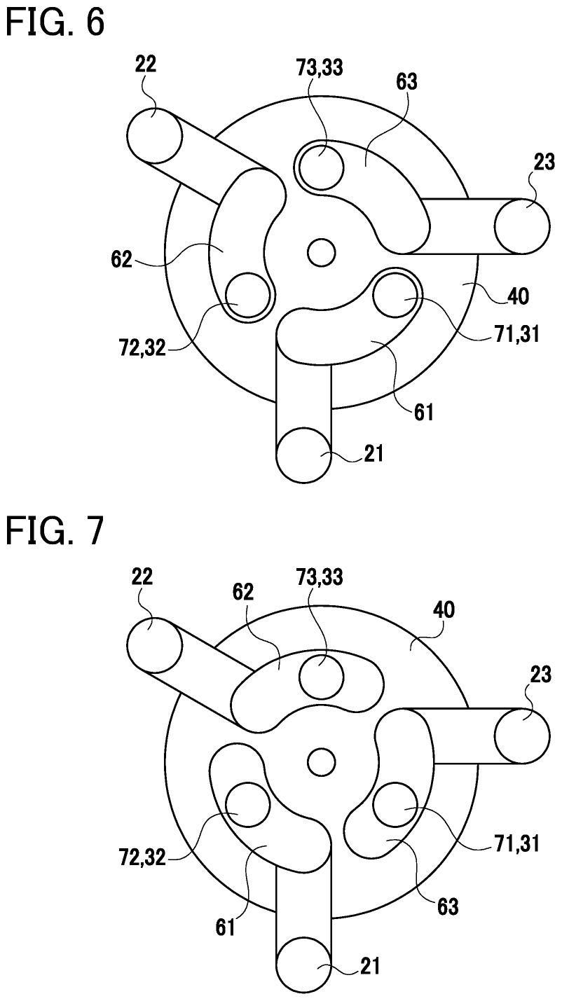

For example, as shown in FIG. 6, a first pattern of flow passage combination is formed as follows. Specifically, a flow passage communicating the first inflow channel 21 with the first outflow channel 31 can be formed by communicating the first rotary disk communication path 61 communicated with the first inflow channel 21 and the first fixed disk communication path 71 communicated with the first outflow channel 31. Further, a flow passage communicating the second inflow channel 22 with the second outflow channel 32 can be formed by communicating the second rotary disk communication path 62 communicated with the second inflow channel 22 and the second fixed disk communication path 72 communicated with the second outflow channel 32. Furthermore, a flow passage communicating the third inflow channel 23 with the third outflow channel 33 can be formed by communicating the third rotary disk communicating path 63 communicated with the third inflow channel 23 and the third fixed disk communication path 73 communicated with the third outflow channel 33.

Further, the first pattern of flow passage combination shown in FIG. 6 can be switched to a second pattern of the flow passage combination shown in FIG. 7 by driving and rotating the rotary disk 40 by the drive part 13. To be specific, as shown in FIG. 7, the second pattern of the flow passage combination is formed as follows. A flow passage communicating the first inflow channel 21 communicated with the second outflow channel 32 can be formed by communicating the first rotary disk communication path 61 communicated with the first inflow channel 21 and the second fixed disk communication path 72 communicated with the second outflow channel 32. Further, a flow passage communicating the second inflow channel 22 with the third outflow channel 33 can be formed by communicating the second rotary disk communication path 62 communicated with the second inflow channel 22 and the third fixed disk communication path 73 communicated with the third outflow channel 33. Furthermore, a flow passage communicating the third inflow channel 23 with the first outflow channel 31 can be formed by communicating the third rotary disk communication path 63 communicated with the third inflow channel 23 and the first fixed disk communication path 71 communicated with the first outflow channel 31.

The flow passage switching device 1 may be any one of a multi-port valve such as a three-port valve and a four-port valve other than the six-port valve. Accordingly, the rotary disk 40 only has to include at least one rotary disk communication path 60, and the fixed disk 50 only has to include a plurality of the fixed disk communication paths 70.

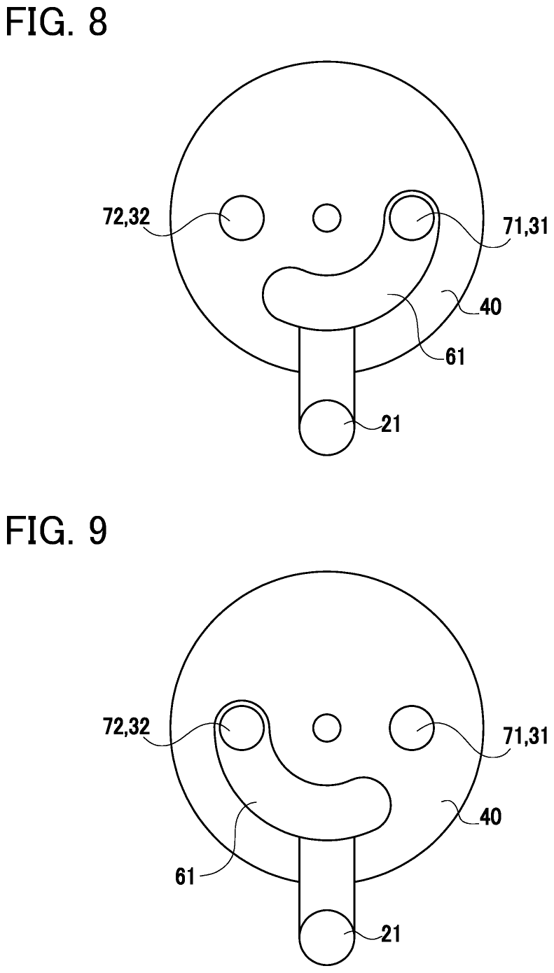

For example, in a case of providing the flow passage switching device 1 as a three-port valve, the housing 11 includes the one inflow channel 20 (namely, the first inflow channel 21) and the two outflow channels 30 (namely, the first outflow channel 31 and the second outflow channel 32). Further, the rotary disk 40 includes the one rotary disk communication path 60 (namely, the first rotary disk communication path 61). Further, the fixed disk 50 includes the two fixed disk communication paths 70 (namely, the first fixed disk communication path 71 and the second fixed disk communication path 72). As shown in FIG. 8 and FIG. 9, the flow passages are switchable. Herein, the rotary disk 40 may be provided with the two rotary disk communication paths 60 (namely, the first rotary disk communication path 61 and the second rotary disk communication path 62).

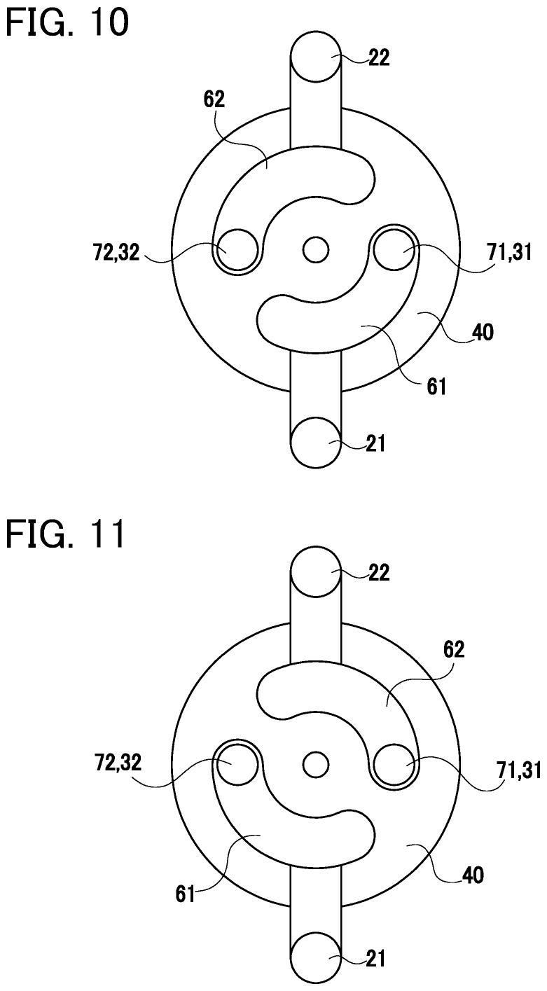

In another case of providing the flow passage switching device 1 as a four-port valve, the housing 11 includes the two inflow channels 20 (namely, the first inflow channel 21 and the second inflow channel 22) and the two outflow channels 30 (namely, the first outflow channel 31 and the second outflow channel 32). The rotary disk 40 includes the two rotary disk communication paths 60 (namely, the first rotary disk communication path 61 and the second rotary disk communication path 62). The fixed disk 50 includes the two fixed disk communication paths 70 (namely, the first fixed disk communication path 71 and the second fixed disk communication path 72). As shown in FIG. 10 and FIG. 11, the flow passages are switchable.

Rotary Disk and Fixed Disk

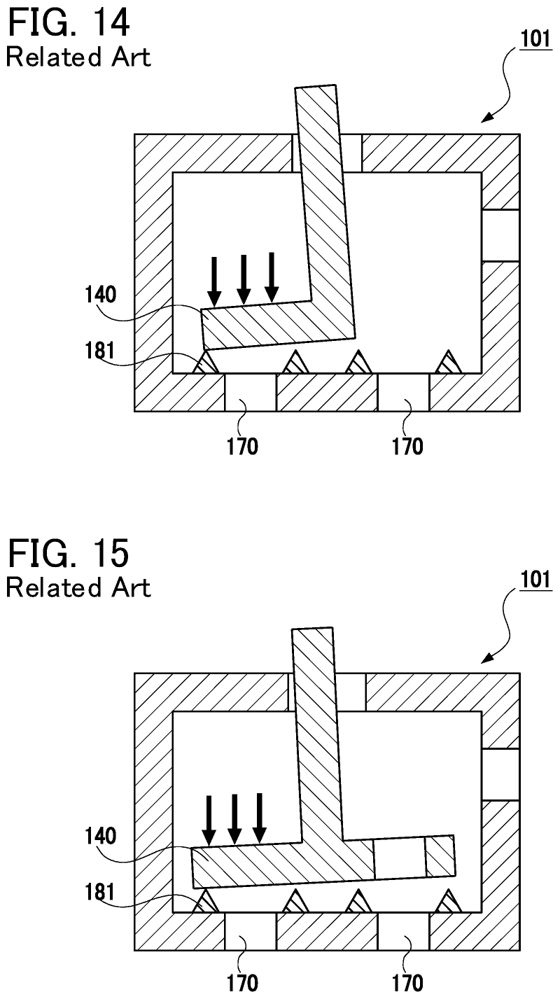

As shown in FIG. 14 and FIG. 15, in a flow passage switching device 101 of a conventional art as disclosed in the Japanese patent application publication No. 2022-21966, there is a possibility that a rotary disk 140 is tilted by the fluid pressure (as indicated with arrows in the figure) to fail to keep its posture. This could result in degradation in the sealing performance of a fixed disk communication path 170 which could cause failure in preventing leakage of the fluid from the fixed disk communication path 170 and result in uneven wear of a sealing member 181 for ensuring the sealing performance of the fixed disk communication path 170.

Further, in rotation of the rotary disk 140, the sliding resistance generated between the rotary disk 140 and the sealing member 181 is increased due to the fluid pressure, and thus there needs to increase the torque of a motor of the drive part for driving and rotating the rotary disk 140. This could cause increase in a size of the drive part and increase in a manufacturing cost for the drive part. Furthermore, the flow passage switching device 101 of the conventional art has a possibility that the device cannot deal with complicated switching of flow passages.

In the present embodiment, the valve element part 12 provided in the housing 11 includes the rotary disk 40 and the fixed disk 50. The present embodiment thus exemplifies the valve element part 12 as a double-layered disk structure so that such complicated switching of flow passages can be achieved as explained above with reference to FIG. 6 to FIG. 11. Flow passages can be switched only by changing the position of the rotary disk communication paths 60 of the rotary disk 40, thereby requiring no further components for flow passage switching. Accordingly, the present embodiment can achieve downsizing of the flow passage switching device 1 and also achieve easy switching of various flow passages.

Further, in the present embodiment, elastic members are each provided between the housing 11 and the rotary disk 40, between the rotary disk 40 and the fixed disk 50, and between the fixed disk 50 and the housing 11 in the axial direction.

Specifically, as shown in FIG. 3, sealing members 81 as the elastic member are each provided between a top face 11a of the housing 11 and a top face 41a of the circular plate portion 41 of the rotary disk 40 and between a lower face 41b of the circular plate portion 41 of the rotary disk 40 and a top face 51a of the circular plate portion 51 of the fixed disk 50. The sealing members 81 are formed to each circumferentially surround the rotary disk communication path 60, which is formed to be of an oblong shape, on the top face 41a and the lower face 41b of the circular plate portion 41 of the rotary disk 40. The sealing members 81 are to prevent leakage of the fluid from the rotary disk communication paths 60. Herein, the sealing members 81 are made of fluororesin such as Teflon (Japanese registered trademark). Further, the sealing members 81 may be formed of a rubber put with fluororesin.

Further, as shown in FIG. 3, disk holding springs 82 as the elastic member are provided between the lower face 51b of the circular plate portion 51 of the fixed disk 50 and the lower face 11b of the housing 11. The disk holding springs 82 are placed to each surround an outer circumferential surface of each of the three cylinder portions 52 of the fixed disk 50.

As mentioned above, the disk holding springs 82 have the function of pushing the fixed disk 50 to the rotary disk 40, and the three disk holding springs 82 in total are each placed around each of the three cylinder portions 52 of the fixed disk 50. The three disk holding springs 82 are provided to be evenly spaced apart from one another, and thus the fixed disk 50 can be pushed to the rotary disk 40 in a horizontal state as compared with a case of a second embodiment explained below, so that the rotary disk 40 is prevented from tilting.

Further, the three disk holding springs 82 each having a small diameter are provided, which makes a length of the respective disk holding springs 82 shorter than a case of providing one disk holding spring 82 having a large diameter in the outer circumferential portion, thus downsizing the flow passage switching device 1.

The three disk holding springs 82 may be placed in each space among the three cylinder portions 52. Alternatively, four or more of the disk holding springs 82 may be provided. There is also provided a lip seal 83 between the cylinder portion 52 of the fixed disk 50 and the housing 11 for ensuring the sealing performance of the fixed disk communication path 70.

In the present embodiment, the elastic members are provided in each space among the housing 11, the rotary disk 40, and the fixed disk 50 in the axial direction so that the elastic members hold the rotary disk 40 and the fixed disk 50. Therefore, the sliding resistance generated by application of the fluid pressure can be restrained owing to the influence of the floating property, and thus the sealing members 81 provided to ensure the sealing property of the rotary disk communication paths 60 and the fixed disk communication paths 70 can be prevented from uneven wear.

Leakage of the fluid from the rotary disk communication paths 60 and the fixed disk communication paths 70 can be therefore assuredly prevented by the sealing members 81. This results in further assured sealing performance of the flow passage which is constituted by the inflow channels 20, the rotary disk communication paths 60, and the fixed disk communication paths 70. Further, the sealing members 81 provided for ensuring this sealing property of the flow passage can be prevented from uneven wear.

Further, the elastic member for keeping the posture of the rotary disk 40 and the fixed disk 50 can be used as the sealing members 81 of the rotary disk communication paths 60. Accordingly, there is no need to separately prepare an elastic member, thus achieving prevention of increase in the number of components and achieving downsizing of the flow passage switching device 1. Furthermore, the axial direction of the rotary disk 40 and the fixed disk 50 are aligned with a sealing direction of the sealing members 81, and thus the sealing performance can be ensured even when the rotary disk 40 is misaligned from the central axis during driving and rotating.

The sealing member 81 provided between the housing 11 and the rotary disk 40 and the sealing member 81 provided between the rotary disk 40 and the fixed disk 50 are placed in the same position with respect to a radial direction (namely, a surface direction or a left and right direction in FIG. 3) of the rotary disk 40.

The rotary disk communication paths 60 are thus sealed by the sealing members 81 at the same positions on the top face 41a side and on the lower face 41b side of the circular plate portion 41 of the rotary disk 40, and thus areas where the fluid pressure acts on are the same on the both sides (namely, the top face 41a and the lower face 41b of the circular plate portion 41) of the rotary disk 40. Accordingly, the fluid pressure acting on the top face 41a and the lower face 41b of the circular plate portion 41 are offset while only a resilient force of the disk holding springs 82 is applied to the circular plate portion 41, so that the posture of the rotary disk 40 is maintained.

Owing to the above, the sliding resistance between the rotary disk 40 and the fixed disk 50 during rotation of the rotary disk 40 is reduced, and thereby a motive power of the drive part 13 to rotate and drive the rotary disk 40 can be lowered to save the electric power consumption. Moreover, the load to be given to the sealing members 81 by the rotary disk 40 can be reduced, thus improving credibility in the sealing performance of the sealing members 81.

Further, at least a part of the cylinder portion 52 of the fixed disk 50 is inserted in each of the outflow channels 30.

This insertion of the cylinder portion 52 prevents misalignment of the fixed disk 50 in the circumferential direction due to rotary drive of the rotary disk 40.

Since a direction (namely, a left and right direction in FIG. 3) to which the rotary disk 40 might get misaligned and a sealing direction (namely, an upper and lower direction in FIG. 3) of the sealing members 81 are different from each other, the sealing performance of the sealing members 81 is maintained even if the rotary disk 40 has got misaligned.

Further, the sealing member 81 provided between the housing 11 and the rotary disk 40 and the sealing member 81 provided between the rotary disk 40 and the fixed disk 50 are placed on the same position with respect to the radial direction of the rotary disk 40. Therefore, even if the rotary disk 40 gets tilted due to the fluid pressure and others, the rotary disk 40 can be recovered to be horizontal by the resilient force of the sealing members 81.

Further, the sealing member 81 provides a seal in its circumferential direction and applies an even surface pressure in the horizontal direction, so that the sealing member 81 has less sliding resistance and gets abraded evenly. Accordingly, the rotary disk 40 can be maintained with its horizontal state in years.

### Second Embodiment

A second embodiment is now explained with focusing only on different features from the first embodiment, and explanation for the similar features with the first embodiment is omitted.

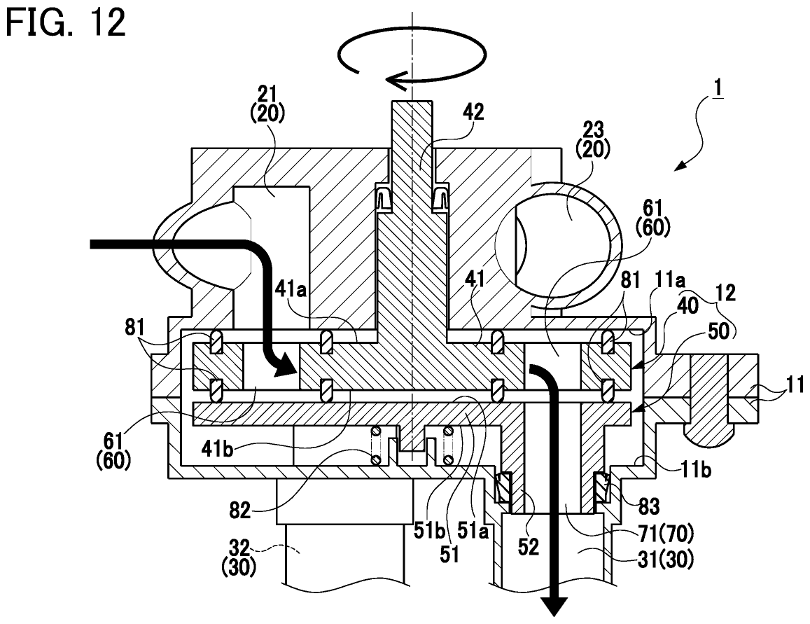

In the present embodiment, as shown in FIG. 12, one disk holding spring 82 is provided as the elastic member. This one disk holding spring 82 may be provided in a center portion in the radial direction of the fixed disk 50 as shown in FIG. 12, or may expand its diameter and be provided on an outer circumferential side of the fixed disk 50.

### Third Embodiment

A third embodiment is now explained with focusing only on different features from the first embodiment and the second embodiment, and explanation for the similar features with the first and second embodiments are omitted.

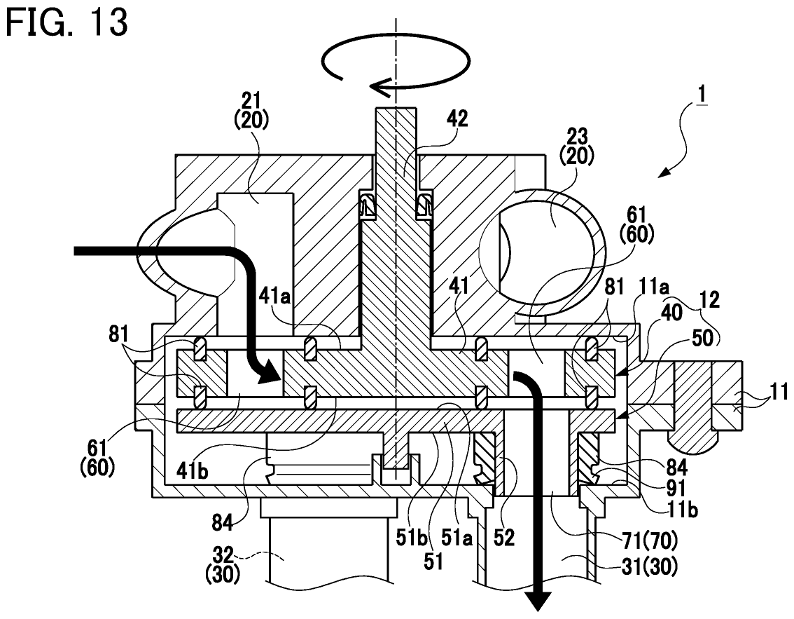

In the present embodiment, as shown in FIG. 13, a disk holding lip seal 84 as the elastic member is provided between the lower face 51b of the circular plate portion 51 of the fixed disk 50 and the lower face 11b of the housing 11. This disk holding lip seal 84 of an almost cylindrical shape is provided in each of the three cylinder portions 52 of the fixed disk 50 to surround an outer circumferential surface of the respective cylinder portions 52. The disk holding lip seals 84 prevent leakage of the fluid from the fixed disk communication paths 70.

The disk holding lip seal 84 is a sealing member made of rubber. Further, the disk holding lip seal 84 is one example of a “fixed disk sealing member” of the present disclosure.

In this manner, the sealing members 81 and the disk holding lip seals 84 can surely prevent leakage of the fluid from the rotary disk communication paths 60 and the fixed disk communication paths 70. Therefore, the sealing property of the flow passage formed by the inflow channels 20, the rotary disk communication paths 60, the fixed disk communication paths 70, and the outflow channels 30 can be assured.

Further, the disk holding lip seal 84 can also take a role of the elastic member for holding the posture of the fixed disk 50. There is thus no need to separately provide an elastic member, thereby achieving restraint of increase in the number of components and achieving downsizing of the flow passage switching device 1.

Further, since a direction in which the rotary disk 40 could be misaligned (namely, a left and right direction in FIG. 13) is different from a sealing direction of the disk holding lip seal 84 (namely, an upper and lower direction in FIG. 13), the sealing performance of the disk holding lip seal 84 can be maintained even if the rotary disk 40 gets misaligned.

Furthermore, the disk holding lip seals 84 provided between the fixed disk 50 and the housing 11 have a function of holding the fixed disk 50 and a function of ensuring the sealing performance of the fixed disk communication paths 70 as a function involving the functions of the disk holding spring 82 and the lip seal 83. The disk holding lip seal 84 is provided with a lip portion 91 that is contacted with the housing 11, and the tightening force of the lip portion 91 acts on the fixed disk 50 in the axial direction.

As mentioned above, the tightening force of the lip portion 91 acts on the fixed disk 50 in the axial direction (in the upper and lower direction in FIG. 13), and thus the lip portion 91 does not slide along the housing 11 when the fixed disk 50 is to move in the axial direction to keep its posture, so that there is no sliding resistance generated between the lip portion 91 and the housing 11. Therefore, the posture of the fixed disk 50 can be further assuredly held.

Further, the tightening force of the lip portion 91 acts on the fixed disk 50 in the axial direction, and thus a position of the fixed disk communication path 70 with respect to the central axis is hardly displaced from a direction (namely, the left and right direction in FIG. 13) orthogonal to the central axis. Therefore, the disk holding lip seal 84 can further assuredly ensure the sealing property of the fixed disk communication path 70.

The above-mentioned embodiments are only illustration, and give no any limitation to the present disclosure. The disclosure may naturally be made with various improvements and modifications without departing from the scope of the disclosure.

For example, the rotary disk 40 and the fixed disk 50 may be of any polygonal plate-like shape such as a hexagonal shape other than the circular plate shape.

### REFERENCE SIGNS LIST

1 Flow passage switching device
11 Housing
12 Valve element part
13 Drive part
20 Inflow channel
21 First inflow channel
22 Second inflow channel
23 Third inflow channel
30 Outflow channel
31 First outflow channel
32 Second outflow channel
33 Third outflow channel
40 Rotary disk
41 Circular plate portion
42 Rotary shaft portion
50 Fixed disk
51 Circular plate portion
52 Cylinder portion
60 Rotary disk communication path
61 First rotary disk communication path
62 Second rotary disk communication path
63 Third rotary disk communication path
70 Fixed disk communication path
71 First fixed disk communication path
72 Second fixed disk communication path
73 Third fixed disk communication path
81 Sealing member
82 Disk holding spring
83 Lip seal
84 Disk holding lip seal
91 Lip portion

What is claimed is:

1. A flow passage switching device comprising:
a housing; and
a valve element part provided in the housing,
the valve element part including a drive disk of a plate-like shape and a fixed disk of a plate-like shape,
the drive disk and the fixed disk being stacked in an axial direction,
the drive disk including at least one drive disk communication path penetrating in the axial direction,
the fixed disk including a plurality of fixed disk communication paths penetrating in the axial direction, and
the drive disk being driven and rotated to switch a flow passage by changing combination of the drive disk communication path and the fixed disk communication path which communicate with each other, wherein
elastic members are each provided in the axial direction between the housing and the drive disk, between the drive disk and the fixed disk, and between the fixed disk and the housing.

2. The flow passage switching device according to claim 1, wherein at least one of the elastic members is a sealing member to prevent leakage of a fluid from any one of the drive disk communication path and the fixed disk communication path.

3. The flow passage switching device according to claim 2, wherein the sealing member provided between the housing and the drive disk and the sealing member provided between the drive disk and the fixed disk are placed in the same position with respect to a surface direction of the drive disk.

4. The flow passage switching device according to claim 1, wherein
at least one of the elastic members which is provided between the fixed disk and the housing is a fixed disk sealing member to prevent leakage of a fluid from the fixed disk communication path, and
a tightening force of the fixed disk sealing member acts in the axial direction.

5. The flow passage switching device according to claim 1, wherein
the housing includes an outflow channel communicated with the fixed disk communication path,
the fixed disk includes a cylinder portion formed to surround the fixed disk communication path, and
at least a part of the cylinder portion is inserted in the outflow channel.

6. The flow passage switching device according to claim 2, wherein
at least one of the elastic members which is provided between the fixed disk and the housing is a fixed disk sealing member to prevent leakage of a fluid from the fixed disk communication path, and
a tightening force of the fixed disk sealing member acts in the axial direction.

7. The flow passage switching device according to claim 3, wherein
at least one of the elastic members which is provided between the fixed disk and the housing is a fixed disk sealing member to prevent leakage of a fluid from the fixed disk communication path, and
a tightening force of the fixed disk sealing member acts in the axial direction.

8. The flow passage switching device according to claim 2, wherein
the housing includes an outflow channel communicated with the fixed disk communication path,
the fixed disk includes a cylinder portion formed to surround the fixed disk communication path, and
at least a part of the cylinder portion is inserted in the outflow channel.

9. The flow passage switching device according to claim 3, wherein
the housing includes an outflow channel communicated with the fixed disk communication path,
the fixed disk includes a cylinder portion formed to surround the fixed disk communication path, and
at least a part of the cylinder portion is inserted in the outflow channel.
